(19) United States
(12) Patent Application Publication
(10) Pub. No.: US 2008/0223210 A1
(43) Pub. Date: Sep. 18, 2008

(54) Reciprocating Piston Machine

(75) Inventor: Jan Hinrichs, Friedrichsdorf (DE)

Correspondence Address: Davidson, Davidson & Kappel, LLC, 485 7th Avenue, 14th Floor, New York, NY, 10018, US

(73) Assignee: LuK Fahrzeug-Hydraulik GmbH & Co. KG, Bad Homburg (DE)

(21) Appl. No.: 11/666,776

(22) PCT Filed: Oct. 20, 2005
(86) PCT No.: PCT/DE2005/001869

§ 371 Date: May 1, 2007

(30) Foreign Application Priority Data
Nov. 5, 2004 (DE) 10 2004 053 483.7

(51) Int. Cl. F16J 15/18

(52) U.S. Cl. 92/168

(57) ABSTRACT

A reciprocating piston machine, such as an air-conditioning compressor for motor vehicles, having a housing, a a rotationally drivable shaft, a shaft sealing device, in particular a mechanical shaft seal, at least one radial shaft bearing, especially a radial rolling-contact bearing, and at least one axial shaft bearing, in particular an axial rolling-contact bearing, a bearing sleeve which accommodates at least the radial shaft bearing, being configured within an opening in the housing, extending into the same.

The present invention relates to a reciprocating piston machine, such as an air-conditioning compressor for motor vehicles, having a housing, a rotationally drivable shaft, a shaft sealing device, in particular a mechanical shaft seal, having at least one radial shaft bearing, in particular a radial rolling-contact bearing, having at least one axial shaft bearing, in particular an axial rolling-contact bearing, a bearing sleeve, which accommodates at least the radial shaft bearing, being configured within an opening in the housing, extending into the same.

Reciprocating piston machines of this kind are generally known.

In this context, the bearing sleeve and the housing are joined to one another by a weld seam, for example, the weld seam being placed in a region that is subject to highly fluctuating loads and, in the event of failure of the weld seam, there being the risk of parts of the housing loosening.

It is, therefore, an object of the present invention to devise a reciprocating piston machine which will overcome these disadvantages.

The objective is achieved by a reciprocating piston machine, such as an air-conditioning compressor for motor vehicles, having a housing, a rotationally drivable shaft, a shaft sealing device, in particular a mechanical shaft seal, having at least one radial shaft bearing, in particular a radial rolling-contact bearing, having at least one axial shaft bearing, in particular an axial rolling-contact bearing, a bearing sleeve, which accommodates at least the radial shaft bearing, being configured within an opening in the housing, extending into the same, the bearing sleeve having a first collar, which, viewed from the housing side, outwardly from the inside, comes to rest within the housing in the axial direction, against an annular contact surface in a recess within the housing, so that axial forces acting on the bearing sleeve outwardly from the inside when viewed from the housing side, are able to be absorbed by the housing (introduced into the housing) by the action of positive engagement.

A reciprocating piston machine is preferred, where a second smaller-diameter collar, which extends through an opening of the housing, is configured axially upstream of the first contact collar, when viewed from the housing side, outwardly from the inside. In addition, a reciprocating piston machine is preferred where the first collar, together with the second collar, constitute one common stepped collar, which extends through the opening of the housing, engaging positively therewith in the radial and axial directions.

A reciprocating piston machine according to the present invention has the distinguishing feature that the radially outer region of the second collar, together with the radially inner region of the opening of the housing, form a common region for introducing a weld seam. Here the advantage is derived that, particularly with regard to axial forces produced by the axial shaft bearing, the weld seam is located in the area that is subject to less load since the axial forces may be introduced into the housing by way of the first collar. Even in the event of failure of the weld seam, the bearing sleeve would be held securely by the axial forces within the housing, in positive engagement therewith.

In addition, a reciprocating piston machine is preferred where, at one axial end face within the housing, the bearing sleeve accommodates the axial shaft bearing. A reciprocating piston machine is also preferred where the bearing sleeve accommodates the radial shaft bearing within a radial recess. A reciprocating piston machine is also preferred where the bearing sleeve accommodates a mechanical shaft seal within an additional radial recess.

A reciprocating piston machine according to the present invention has the distinguishing feature that, between the regions where the mechanical shaft seal and the radial shaft bearing are located, the bearing sleeve has lubricant passage bores for the mechanical shaft seal and the radial shaft bearing. A reciprocating piston machine is also preferred where, radially outwardly within the housing, the bearing sleeve has a groove which functions as a lubricant-collecting groove and contains the lubricant passage bores.

It is a distinguishing feature of another reciprocating piston machine according to the present invention that the bearing sleeve is provided outside of the housing with a region for accommodating a rolling-contact bearing of a belt pulley.

Overall, therefore, by using a bearing sleeve of this kind in combination with an air-conditioning compressor housing, the advantage is derived that a small bearing sleeve component is easier to clamp and machine than a large housing, and that the seat of the inner bearing and the seat of the outer bearing may be machined in one clamping operation, thereby permitting narrower tolerances and a more efficient operation of the machine.

The present invention is described with reference to the figures, which show:

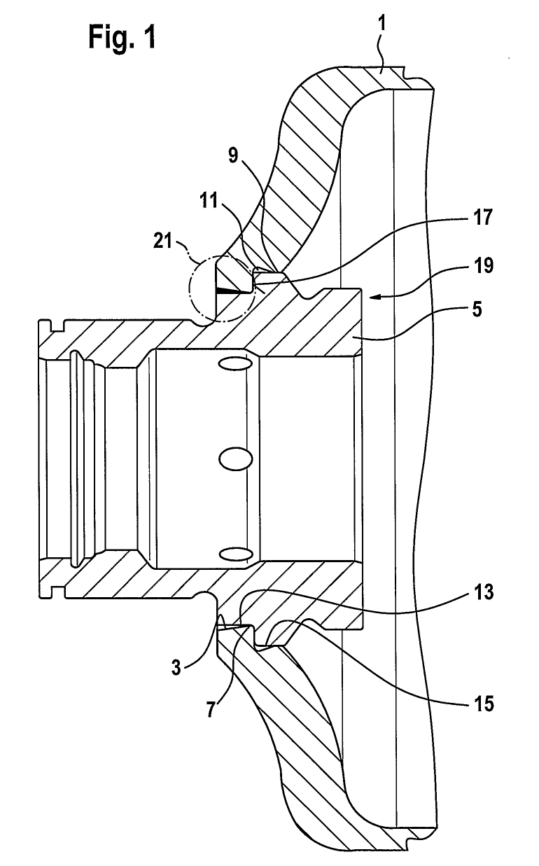

FIG. 1 a bearing sleeve according to the present invention in cross section in one part of the housing;

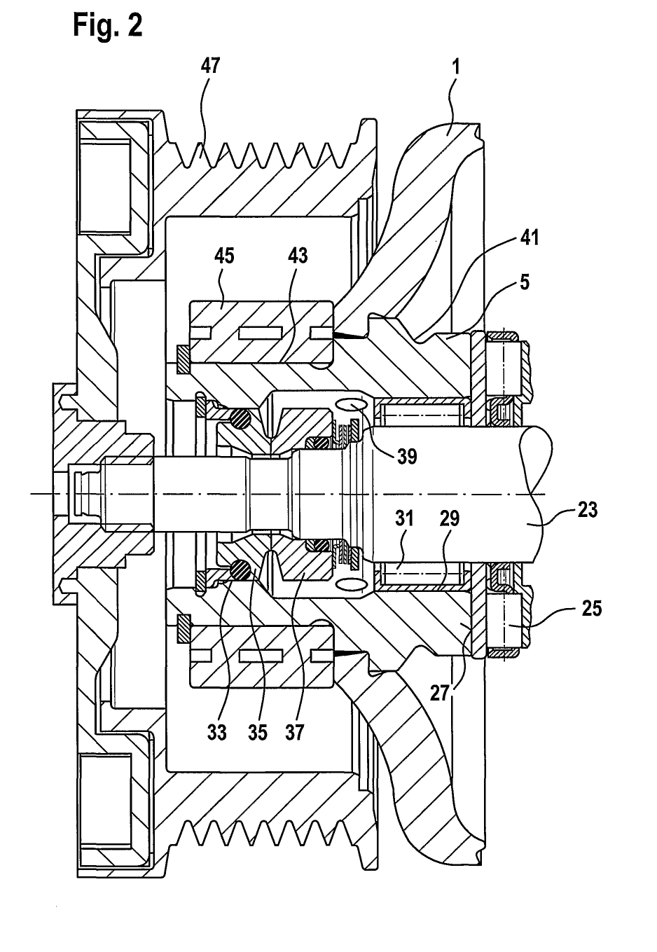

FIG. 2 a sectional view of a compressor in the area of the bearing sleeve according to the present invention;

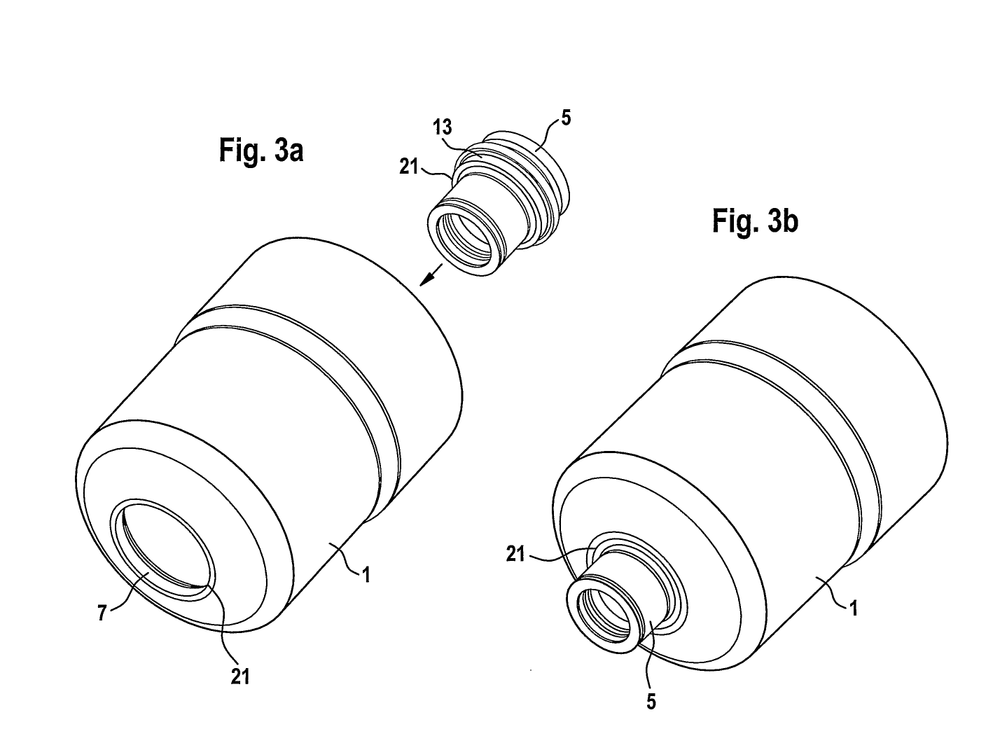

FIG. 3 in a perspective representation, a bearing sleeve according to the present invention and the corresponding housing.

A bearing sleeve 5 is inserted in an opening 3 in a housing section 1 of an air-conditioning compressor. Opening 3 has a smaller-diameter part 7 and a larger-diameter part 9, so that, for all intents and purposes, opening 3 is a stepped, annular opening. In region 11, larger-diameter part 9 of the stepped bore of the housing is enlarged to a somewhat greater degree by a radially outwardly extending undercut. By way of a smaller-diameter collar 13 and a larger-diameter collar 15, bearing sleeve 5 engages in this stepped recess 3 of housing 1, thereby producing an axial contact surface 17 between bearing sleeve 5 and housing part 1. Since axial forces act on bearing sleeve 5 in the direction of arrow 19 via an axial shaft bearing from the power unit of the compressor, bearing sleeve 5 is pressed at contact surface 17 against housing 1 in positive engagement therewith. Thus, the axial forces are introduced from the compressor power unit into housing 1 via contact surface 17. As a result, smaller-diameter collar 7 of the housing, respectively smaller-diameter collar 13 of bearing sleeve 5 are disposed in a region where axial forces no longer act. Thus, as the area that is subject to less load, this region 21 between housing collar 7 and bearing sleeve collar 13 is suited in accordance with the present invention for producing a weld seam for joining bearing sleeve 5 to housing 1. Even if the weld seam in this region 21 were to become defective under certain circumstances, then the axial forces of the power unit acting in arrow direction 19 would ensure that bearing sleeve 5 is pressed by the axial forces against housing 1 in positive engagement therewith, and thus that the function is maintained between bearing sleeve 5 and housing 1.

FIG. 2 shows a cross section through the corresponding part of the air-conditioning compressor having housing part 1 and bearing sleeve 5. Extending completely through bearing sleeve 5 is a drive shaft 23, which is supported by an axial shaft bearing 25 on an axial end face 27 of bearing sleeve 5. In addition, shaft 23 is supported by a radial rolling-contact bearing 31 in region 29 of bearing sleeve 5. A mechanical shaft seal having a fixed part 35 and a rotating part 37 are located in a front region 33 of bearing sleeve 5. Lubricant passage bores 39, which lead from the interior space of sleeve 5 outwardly into a circumferential groove 41 that wraps around sleeve 5, are disposed between region 29 of the radial rolling-contact bearing and region 33 of the mechanical shaft seal. In this context, groove 41 in the drive chamber of the compressor functions as a lubricant-collecting groove. It directs lubricant via passage bores 39 into the region of the bearing sleeve between mechanical shaft seal 35/37 and radial rolling-contact bearing 31. Thus, both mechanical shaft seal 35/37, as well as radial rolling-contact bearing 31 are supplied with lubricant within bearing sleeve 5. A rolling-contact bearing 45, which supports belt pulley 47, is arranged on outer surface 43 of bearing sleeve 5 outside of housing 1. Thus, when manufacturing bearing sleeve 5, both the bearing surfaces for radial rolling-contact bearing 31, as well as radial rolling-contact bearing 45 may be fabricated in one clamping operation, thereby permitting a more favorable machining process in terms of tolerances. In this context, by dividing the compressor housing into one large housing part 1 and one smaller bearing sleeve part 5, it is ensured that a small component may be used for machining the bearing seats that is easier to clamp and to machine than a large one-piece housing which, otherwise, would have to have these corresponding bearing seats.

In FIG. 3a, bearing sleeve 5 and complete housing component 1 are shown separately and, in FIG. 3b, in the assembled state. The corresponding weld seam is applied in region 21 between housing 1 and bearing sleeve 5, in this region, it being preferable to apply a laser weld which may be produced on a very narrow region having a great depth, as is discernible in the cross section of FIG. 1, in region 21.

Thus, a cost reduction is achieved by the inventive approach for designing bearing sleeve 5 and housing part 1, due to the improved machinability of sleeve 5, as is an enhanced component reliability, due to proper positioning of the stepped collar and the weld seam. Even in the event of failure of the weld seam, a secure form-locking connection is ensured by the positive engagement between sleeve 5 and housing 1 in the direction of axial forces 19.

### List of Reference Numerals

1 air-conditioning compressor housing

3 opening in the housing

5 bearing sleeve

7 smaller-diameter part of the opening

9 larger-diameter part of the opening

11 undercut region of the stepped bore

13 smaller-diameter collar of the bearing sleeve

15 larger-diameter collar of the bearing sleeve

17 axial contact surface of the bearing sleeve

19 direction of the axial forces

21 area subject to less load by axial forces (weld seam area)

23 drive shaft

25 axial shaft bearing

27 axial end face of the bearing sleeve

29 region for the radial rolling-contact bearing

31 radial rolling-contact bearing

33 region of the bearing sleeve for the mechanical shaft seal

35 fixed part of the mechanical shaft seal

37 rotating part of the mechanical shaft seal

39 lubricant passage bores

41 circumferential lubricant-collecting groove

43 outer surface of the bearing sleeve outside of the housing

45 rolling-contact bearing for the belt pulley

47 belt pulley

1-10. (canceled)

11. A reciprocating piston machine comprising:
a housing having an opening, a recess and an inside;
a rotationally drivable shaft;
a shaft sealing device having at least one radial shaft bearing and at least one axial shaft bearing; and
a bearing sleeve accommodating at least the radial shaft bearing, the bearing sleeve being configured within the opening in the housing, extending into the inside of the housing, the bearing sleeve having a first collar resting within the housing in an axial direction, on an annular contact surface in the recess so that axial forces acting on the bearing sleeve outwardly from the inside, are able to be absorbed by the housing by action of positive engagement.

12. The reciprocating piston machine as recited in claim 11 wherein the shaft sealing device includes a mechanical shaft seal.

13. The reciprocating piston machine as recited in claim 11 wherein the radial shaft bearing is a rolling-contact bearing.

14. The reciprocating piston machine as recited in claim 11 wherein the axial shaft bearing is a rolling-contact bearing.

15. The reciprocating piston machine as recited in claim 11 wherein the bearing sleeve has a second collar extending through the opening and being of smaller diameter than the first collar, and located axially away with respect to the inside from the first collar.

16. The reciprocating piston machine as recited in claim 15 wherein the first collar, together with the second collar, define one common stepped collar, extending through the opening of the housing, engaging positively with the opening in the radial and axial directions.

17. The reciprocating piston machine as recited in claim 15 wherein a radially outer region of the second collar, together with a radially inner region of the opening of the housing, form a common region capable of receiving a weld seam.

18. The reciprocating piston machine as recited claim 11 wherein the bearing sleeve accommodates the axial shaft bearing at one axial end face within the housing.

19. The reciprocating piston machine as recited in claim 11 wherein the bearing sleeve accommodates the radial shaft bearing within a radial recess.

20. The reciprocating piston machine as recited in claim 12 wherein the bearing sleeve accommodates the shaft seal within an additional radial recess of the bearing sleeve.

21. The reciprocating piston machine as recited in claim 12 wherein between regions where the radial shaft bearing and the mechanical shaft seal are located, the bearing sleeve has lubricant passage bores for the mechanical shaft seal and the radial shaft bearing.

22. The reciprocating piston machine as recited in claim 21 wherein, radially outwardly within the housing, the bearing sleeve has a lubricant-collecting groove and containing the lubricant passage bores.

23. The reciprocating piston machine as recited in claim 11 wherein the bearing sleeve is provided outside of the housing with a region for accommodating a rolling-contact bearing of a belt pulley.

24. The reciprocating piston machine as recited in claim 11 wherein the reciprocating piston machine is an air-conditioning compressor for motor vehicles.
